(19) United States
(12) Patent Application Publication
(10) Pub. No.: US 2025/0319814 A1
(43) Pub. Date: Oct. 16, 2025

(54) Straight Turn Signal

(71) Applicant: Jacob Graham, Chicago, IL (US)

(72) Inventor: Jacob Graham, Chicago, IL (US)

(21) Appl. No.: 18/831,497

(22) Filed: Mar. 3, 2025

Related U.S. Application Data
(60) Provisional application No. 63/558,015, filed on Feb. 26, 2024.

(51) Int. Cl. B60Q 1/46; B60Q 1/50

(52) U.S. Cl. CPC B60Q 1/46; B60Q 1/507; B60Q 1/508; B60Q 2800/10; B60Q 2900/40

(57) ABSTRACT

A turn signal system and a multi-vehicle system including the turn signal system are disclosed for creating the safe and efficient movement of objects through physical space. The turn signal system includes a straight turn signal. The straight turn signal according to embodiments disclosed herein delivers safe and clear messaging to users of pathways or roads and adds predictability. It also removes the excuse for a non-signal over the prior art methods for signaling-thus contributing to the reduction of road rage and the statement “why did you not signal.”

### 1. FIELD

This invention relates to traffic engineering and safety. More particularly, the inventions relates to a straight turn signal for creating and coordinating safe movement of objects and facilitating the clear and efficient messaging and movement of objects such as pedestrians, vehicles, bicycles, drones, and planes through reality. This invention claims priority to provisional patent application 63/558,015.

### 2. BACKGROUND

The passage of California Bill A.B. 1909 marks a significant stride in the quest for safer movement of objects, such as bicyclists, pedestrians, motorists, drones, and planes though reality. This legislation introduces the Leading Pedestrian Interval (LPI), a critical feature that grants objects such as pedestrians and cyclists a precious few seconds head start at roadway traffic intersections before vehicles are signaled to proceed. This initiative is more than a mere adjustment to traffic signals; it is a shift towards recognizing and prioritizing the most vulnerable objects and road users, pedestrians, and bikers. The LPI's impact is backed by compelling statistics from organizations like the National Association of City Transportation Officials and the NYC Department of Transportation, showcasing a dramatic decrease in pedestrian-vehicle collisions. The cost-effectiveness of implementing LPI, as highlighted by the U.S. Federal Highway Administration, further solidifies its value proposition. However, while A.B. 1909 is undeniably a leap forward, it represents just one piece of the complex puzzle of road safety.

Amidst these advancements lies a glaring omission in our approach to holistic road safety. Traditional left and right signals and indicators on objects such as vehicles assist with creating a safe and efficient way for objects to move through reality. Yet, crashes between objects due to mis-signaling, failing to signal, inability to signal, and inability to coordinate signaling places in which an object anticipates to move still happen. According to the World Health Organization, approximately 1.3 million people die each year as a result of traffic crashes, and between 20 and 50 million more people suffer non-fatal injuries, with many incurring a disability as a result of their injury. The ambiguity that currently haunts intersections, where objects such as pedestrians and cyclists are often left guessing a vehicle's intention, demands a solution. A vehicle's failure to indicate a turn should not be the cause of confusion or, worse, accidents.

Traffic engineering has introduced solutions other than the LPI, of course, for more safe and efficient travel. It is believed that the first mechanical signaling arm was introduced by Percy Douglas-Hamilton, a Birmingham, England, based inventor, in 1907. This early version was a manual device that the driver had to operate to show intentions to turn left or right. Then, in 1938, the modern electric turn signal was patented in 1938 by Joseph Bell, an African American inventor. His design was among the first to use electrical signals to indicate a vehicle's intentions to turn left or right, marking a significant advancement in automotive safety technology. These innovations greatly improved road safety by providing a method for drivers to communicate their intentions to others on the road, but problems still exist.

Other examples in the prior art include the following: The integration of left and right turn signaling with brake lights and rear lights. The introduction of LED Lighting for turn signals provides brighter illumination, faster response times, and lower power consumption compared to traditional incandescent bulbs. Sequential turn signals illuminate in a sequence to more visually convey the direction in which the vehicle is turning. This feature enhances the visibility and aesthetic appeal of the turn signal. The sequential pattern, however, moves in the direction of the intended turn of only left or right. Turn signals are universally recognized for indicating left or right turns and lane changes. The side mirror and side body turn signal, which integrates a turn signal indicator into side mirrors and the side body of vehicles. Automatic turn signal cancellation in more modern vehicles have sophisticated mechanisms for automatic turn signal cancellation after completing a turn, based on steering wheel movement, vehicle speed, or a combination of factors. This feature helps prevent driver forgetfulness from leaving turn signals blinking unnecessarily, which can be confusing to other drivers. Adaptive lighting systems where the turn signals can adjust their intensity based on the ambient light conditions. Haptic feedback and advanced user interfaces can be used in turn signal systems and can include visual or auditory cues on the vehicle's dashboard or infotainment system to indicate the activation and deactivation of turn signals. Some vehicles use the turn signal lights as part of an emergency braking indication system, where the lights flash rapidly to warn vehicles behind of sudden braking.

More recently, Vikash V. Gayah, a traffic engineer at Pennsylvania State University opined on The Planet Money podcast that eliminating the left turn in certain areas or situations (e.g., in a downtown city area) may improve safety, efficiency, and congestion. When asked in January 2024 by the inventor about whether a straight turn signal was a viable option, Professor Gayah commented that he had not heard of the straight turn signal before but thinks anything that provides more clear and simple messaging could be helpful, especially for non-automobile roadway users.

The above solutions highlight the ongoing evolution of automotive technology, aiming to improve road safety, communication between drivers, and overall driving experience, but clearly problems exist and improvements are needed. Accordingly, there remains a need for turn signal solutions that provide objects with safe, efficient, and easy ways to navigate. The invention herein relates to a straight turn signal that solves or alleviates the foregoing problems.

### SUMMARY

According to embodiments disclosed herein, the straight turn signal stands as a beacon of clarity in murky scenarios, unmistakably indicating an object's (e.g., vehicle's) intention to continue ahead. The straight turn signal introduces a new dialect in the language of road safety. It's a straightforward yet profound communication tool that speaks volumes in the split seconds that often decide the outcomes at intersections. The straight turn signal, according to embodiments disclosed herein, eliminates the dangerous guesswork and hesitancy that plague our streets and plague bikers, replacing uncertainty with predictability. For instance, cyclists, who rely heavily on interpreting vehicle signals to navigate safely, may find the straight turn signal as a game-changer they need to navigate city routes with less likelihood of being hit or experiencing a “right hook collision.” In a right hook scenario, the vehicle turns right across the path of a cyclist who is either in a bike lane or on the right side of the road, leading to a collision. Right hook accidents are a significant concern in urban and suburban areas where bicycles and motor vehicles share close quarters. These incidents highlight the importance of proper signaling by drivers and the need for a straight turn signal, which according to embodiments disclosed herein may be automated with AI systems and controls or coordinated between vehicles on a common grid or software system.

Pedestrians, too, may benefit immensely, gaining a straight understanding of when it's safe to cross. Most people dislike a wishy-washy driver and waffling signaler. The tangible reduction of road rage also cannot be understated, especially given how road rage is the root of other violence. With a straight turn signal and less rage, “The Beef,” an award-winning show on Netflix, may not have occurred.

In embodiments disclosed herein, the potential of the straight turn signal further unfolds when paired with other technology. A turn signal system may not be manually operated and may be enhanced through artificial intelligence. A turn signal system comprising a straight turn signal may be integrated into the vehicle's electrical system. Such a setup may analyze various factors like the vehicle's speed, trajectory, and the proximity of intersections to automatically activate the straight turn signal and coordinate among objects on the road with other electrical, software, and/or AI systems. An automated system, for example, removes the all-too-human element of error, ensuring that signaling is used perhaps more consistently and accurately. The straight turn signal introduces a new signal and a smarter, more intuitive road or air navigation system.

Moreover, a straight turn signal is also a logical step and progressive way to autonomous or driverless vehicles. California banned autonomous cars in some capacities. People have also voiced that they are not ready for these vehicles. People fear, reasonably or unreasonably, that machine-cars may take away jobs, may cause more accidents, and may create more traffic and more traffic confusion. On the other hand, a straight turn signal according to embodiments disclosed herein with an optional AI and computer system implementation, improves safety and avoids the social and urban planning, job displacement, AI ethical and accountability, and safety concerns surrounding fully autonomous driving. People and innovators are living and thinking way too far into the future with robots and driverless car, when the present invention provides an easy and crucial baby-step to a safe-road future. The present invention provides a part of the biological journey towards comprehensive navigation safety. The present invention is not merely about adding another light to our vehicles in some embodiments, but reimagines streets as realms of clarity, predictability, and safety for all. According to embodiments disclosed herein, a straight turn signal, coupled with AI-driven automation, is not a distant dream. The present invention provides a tangible step that may require collective action and commitment.

In a first aspect, a turn signal system is disclosed. The turn signal system, according to this aspect, comprises a straight turn signal in connection with an object.

In a second aspect, a vehicle system is disclosed. The vehicle system, according to this aspect, comprises a turn signal system according to the first aspect.

In a third aspect, a multi-vehicle system is disclosed. The multi-vehicle system, according to this aspect, comprises at least a first vehicle and a second vehicle.

Other systems, methods, features, and advantages of the invention will be, or will become, apparent to one with skill in the art upon examination of the following detailed description. It is intended that all such additional systems, methods, features, and advantages be included within this description, be within the scope of the invention, and be protected by the following claims.

### DETAILED DESCRIPTION

Aspects of the disclosed systems may be implemented with electronic and computer devices, distributed computing devices, memory storage devices, and computer networks that allow users, including artificial intelligence users, to perform calculations as well as process, store, and exchange information.

The term “straight turn signal” refers to a physical indicator such as a light (e.g., a red, amber, or yellow light) that indicates that an object anticipates or is planning to move straight on a trajectory or pathway (e.g., road or air) as opposed to moving left or right on a plane. In some embodiments, a turn signal system comprises a spectrum signal comprising a straight turn signal, wherein the spectrum signal signals in a spectrum of a turning radius of an object. For example, the skilled person would understand that the turn signal system comprising a spectrum can signal a 10, 20, 30, 40, 50, 60, 70, 80, 90, 100, 110, 120, 130, 140,. 150, 160, or more degree turn to the right or left of the straight direction.

The term “object” as used herein refers to a physical object that is capable of traveling on a path in physical space. Examples of objects, as that term is used herein, include vehicles, bicycles, tricycles, motorcycles, cars, trucks, automobiles, helicopters, drones, and airplanes.

The term “in communication with” as used herein refers to digital or electronic communication as well as data exchange involving the transfer of signals, data, or information.

The turn signal system comprises a straight turn signal in connection with an object. In some embodiments, the turn signal system comprises a left turn signal, a right turn signal, and a straight turn signal. In some embodiments, a turn signal system comprises a lever in communication with the straight turn signal. The lever can be used as a physical, electronic, or AI input from a user such as a driver or AI user to trigger the straight turn signal. In such embodiments, a turn signal system can comprise a switch in communication with the lever. The lever can engage a switch (which may include a switch assembly or multifunction switch assembly) to send an electrical signal to a circuit in communication with the straight turn signal or to a module such as a body control module (BCM) (e.g., a vehicle's BCM). When a BCM is present, the BCM can act as a central processing unit that controls various functions, such as the lighting system in a vehicle. The BCM may include integration of AI software systems for controlling the straight turn signal. AI software systems are known to those skilled in the art such as WAYMO DRIVE, Bosch Driver, ADAS, FDS, NVIDIA DRIVE, and MOBILEEYE. The turn signal system, in some embodiments, may generally comprise AI software systems. In such embodiments, the module (e.g., BCM) or circuit controls (e.g., turns on, off, brighter, lighter) or activates the straight turn signal on the corresponding object (e.g., vehicle). This may work the same or differently than traditional turn signal systems. In traditional systems, the current flows through the filament of incandescent bulbs or LED lights. In a sequential turn signal system, as known by the skilled person, the BCM controls the timing and sequence in which the LEDs light up, creating the effect where the lights illuminate in a sequence pointing in the direction to turn.

In some embodiments where a circuit is present, the turn signal system comprises a thermal flasher unit in connection with the circuit. The thermal flasher unit can interrupt the circuit at a regular interval, causing the indicator (e.g., light) to blink. The heat generated by current flow can bend a bimetallic strip, breaking the circuit and then cooling it, creating a flashing effect in such embodiments. In some embodiments, the turn signal system comprises an electron flasher (in addition to or as opposed to a BCM or thermal flasher) to control pattern of an indicator flash rate.

In some embodiments, the turn signal system comprises an automatic cancellation system in connection with the straight turn signal. In such embodiments, the automatic cancellation system can be use in connection with a spectrum turn signal system and/or in connection with the straight turn signal to detect the direction of the object and trigger signaling accordingly. When moving the object (e.g., vehicle), a cam or similar device of the automatic cancellation system interacts with the lever to switch it (e.g., switch signals, including the straight turn signal, on, off, or some other form).

In some embodiments, a turn signal system comprises electronic sensors in connection with a steering mechanism (e.g., steering wheel) to sense the steering mechanism position and send a signal to a BCM to cancel, alter, initiate, or change the straight turn signal.

A driver or control of an object, in some embodiments, receives feedback through a display (e.g., dashboard) to communicate in unison with the straight turn signal. The turn signal system comprising a straight turn signal can ensure that the straight turn signal can operate reliably and effectively, providing critical communication between the driver and other road users regarding the object (e.g., vehicle's) intended direction.

In some embodiments, the turn signal system comprises a straight turn signal in connection with an object, wherein the object is in communication with or comprises a GPS system.

In some embodiments, Artificial Intelligence (AI) software can be integrated into the turn signal system to enhance functionality and safety. An existing turn signal system may be updated, for example, with the turn signal system, disclosed herein, comprising a straight turn signal. The existing system update may involve both software and hardware (e.g., circuit, BCM, light, lever, etc.) upgrades. Such software and hardware upgrade may include AI upgrades. Such software upgrades may include the development and deployment of AI software systems including algorithms that can analyze real-time data from the object's sensors (e.g., vehicle's sensors), such as cameras, radar, GPS, and accelerometers and historical data on user behavior (e.g., driver behavior). These algorithms may be capable of predicting when a driver intends to make a turn or lane change and automatically activate the turn signals if the driver fails to do so. Machine learning models could be trained to understand complex driving scenarios and driver habits, improving the predictive accuracy over time. AI systems may be integrated into sensors and cameras if the current object (e.g., vehicle) setup does not adequately capture the necessary data. Such sensors can provide the AI system with information about the vehicle's environment, including the proximity of other vehicles, lane markings, and the vehicle's speed and trajectory. AI systems may include Human-Machine Interface (HMI) Enhancements such as upgrades to a vehicle's dashboard display and audio feedback systems to communicate AI straight turn signal decisions to the driver effectively. This could include visual cues on the dashboard or heads-up display and audible alerts. This may implement feedback mechanisms to allow drivers to override AI decisions when necessary, ensuring that the driver retains ultimate control over the vehicle. AI systems can be used with connectivity and data processing to ensure, for example, a vehicle's onboard computer and processing units are capable of handling the AI algorithms and real-time data processing. This might require hardware upgrades to support increased computational demands. Use of cloud connectivity to update AI models with new data and improvements, ensuring the system benefits from collective learning and advancements in AI. The testing and calibration conduct can include extensive simulations and real-world testing to calibrate the AI system, ensuring it accurately interprets sensor data and driver intentions in a wide range of scenarios with the straight turn signal. Calibration is crucial to balance sensitivity (to avoid missed turns) and specificity (to avoid false activations), ensuring the system is reliable and trustworthy. AI can be used to work with regulatory bodies to ensure the AI-enhanced straight turn signal system complies with all relevant safety standards and regulations. AI can provide education and user acceptance training for drivers on how the AI-enhanced straight turn signal system works, its benefits, and how to interact with it safely and effectively.

It should also be noted that Artificial Intelligence (AI) can significantly enhance the functionality and safety of the turn signal system, according to embodiments disclosed herein. By integrating AI technologies, the turn signal system can become more intuitive, predictive, and adaptive to the surroundings (e.g., driving environment) and the objects habits (e.g., driver's habits). AI can analyze the vehicle's speed, steering wheel angle, GPS navigation data, and past driver behavior to predict when a turn is likely to occur and automatically activate the straight turn signal. This predictive signaling could be particularly useful in situations where the driver forgets to use a turn signal or in complex driving scenarios, such as highway exits or roundabouts. Using data from onboard cameras and sensors, AI can adapt the straight turn signal operation based on the driving context. For example, in tight urban settings with frequent turns, the system could adjust the straight signal timing or pattern to ensure optimal visibility. Conversely, on highways, the AI could extend the duration of the straight turn signal activation to give other drivers more notice. AI can monitor the surrounding environment for potential hazards and adjust the signaling accordingly. If the system detects a pedestrian, cyclist, or another vehicle in a blind spot or approaching from a direction that might intersect with the turn, it could automatically flash the straight turn signal more rapidly or alert the driver to the potential danger, improving safety for everyone on the road. AI can learn from an individual driver's habits and preferences to customize the turn signal system's operation. For drivers who prefer early signaling before turns or lane changes, the system could adapt to activate signals sooner. This personalized approach can enhance driving comfort and ensure consistent use of turn signals. AI systems can provide real-time feedback to drivers about their use of turn signals, such as reminders to deactivate signals after a turn or to use them more consistently. This educational feature could improve driving habits and reduce the likelihood of accidents caused by signaling errors.

By incorporating AI into the turn signal system, according to embodiments disclosed herein, objects can become safer and more intuitive. AI's ability to analyze vast amounts of data in real-time allows for a proactive and adaptive approach to signaling, enhancing communication on the road and reducing the potential for accidents.

A vehicle system is also disclosed. The vehicle system comprises the turn signal system comprising a straight turn signal according to embodiments disclosed above.

A multi-vehicle system is also disclosed. The multi-vehicle system, according to embodiments disclosed herein, comprises at least two vehicles, wherein a first vehicle comprises a turn signal system comprising a straight turn signal, according to embodiments disclosed above, and a second vehicle in communication with the first vehicle and/or the turn signal system of the first vehicle. The second vehicle may comprise a turn signal system comprising a straight turn signal that is the same, similar, or different than the turn signal system of the first vehicle. The vehicles may also be, more broadly, objects instead of just vehicles. By being in communication, the at least first and second vehicle can relay information about each other, including information about the turn signal system(s) such that the vehicles can understand and know, for example, the direction, turning, etc. of each other. In some embodiments, the vehicles can be in communication with each other such that the vehicles can control respective turn signal systems or other software and/or hardware systems of the vehicles, so that they can coordinate safe and efficient directions, turning, physical movement etc. The skilled person would understand that according to these embodiments, the number of vehicles in the multi-vehicle system is not particularly limited and may include hundreds, thousands, or millions of objects or vehicles in communication with each other, including with each others' turn signal systems.

The disclosed systems, herein, may include one or more circuits, modules, sensors, processors, memory registers, network interface controllers, hardware random number generators, network connections, transmission components, computer programs or applications, display screens such as a graphical user interface, or computing devices to implement the disclosed systems. The disclosed systems may include communication over an independent network, block chain network, peer-to-peer network, or internet.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

“We” claim:

1. A turn signal system comprising:
a straight turn signal in connection with an object.

2. The turn signal system of claim 1, wherein the object is a vehicle, plane, or drone.

3. The turn signal system of claim 1, comprising a lever in communication with the straight turn signal, and a switch in communication with the lever, wherein the lever is capable of sending an electrical signal to a body control module (BCM) for control or activation of the straight turn signal.

4. The turn signal system of claim 1, wherein the system comprises a BCM comprising a sequential turn signal system.

5. The turn signal system of claim 1, wherein the system comprises Artificial Intelligence software system.

6. The turn signal system of claim 1, wherein the system comprises a BCM comprising an Artificial Intelligence software system.

7. The turn signal system of claim 1, wherein the system comprises an automatic cancellation system.

8. The turn signal system of claim 1, wherein the system comprises an automatic cancellation system comprising an Artificial Intelligence software system.

9. The turn signal system of claim 1, comprising a body control module and electronic sensors in connection with a steering mechanism to sense the steering mechanism position and send a signal to the body control module to initiate or change the straight turn signal.

10. The turn signal system of claim 1, comprising a GPS system in communication with the straight turn signal, such that when a destination is entered into the GPS system, the straight turn signal is activated when the object intends to go straight.

11. A multi-vehicle system:
a first vehicle comprising a turn signal system comprising a straight turn signal, and a second vehicle in communication with the first vehicle.

13. The multi-vehicle system of claim 11, wherein the first vehicle is in communication with the second vehicle such that the first vehicle and second vehicle can control each other's turn signal systems and can control the moving direction of each vehicle simultaneously.

12. The multi-vehicle system of claim 11, wherein the second vehicle comprises a turn signal system comprising a straight turn signal, wherein the turn signal system of the first vehicle and the turn signal system of the second vehicle are in communication with each other.

14. The multi-vehicle system of claim 11, wherein the multi-vehicle system comprises at least three vehicles, and each of the vehicles comprise a turn signal system comprising a straight turn signal, and each of the vehicles are in communication with each other.

15. The multi-vehicle system of claim 11, wherein the first and second vehicle each comprise a GPS system in communication with the turn signal system.

16. The multi-vehicle system of claim 11, wherein the first and second vehicle each comprise a GPS system in communication with the turn signal system, and wherein the GPS system of the first vehicle is capable of sending messages to the GPS system of the second vehicle, and wherein the GPS system of the second vehicle is capable of sending message to the GPS system of first vehicle and is capable of updating the turn signal system of the first vehicle to activate the straight turn signal.
